(19) United States
(12) Patent Application Publication
(10) Pub. No.: US 2010/0035056 A1
(43) Pub. Date: Feb. 11, 2010

(54) Carpet Tape

(76) Inventor: Benigno G. Perez, Bronx, NY (US)

Correspondence Address: POWER DEL VALLE LLP, 233 WEST 72 STREET, NEW YORK, NY, 10023, US

(21) Appl. No.: 12/187,225

(22) Filed: Aug. 6, 2008

(51) Int. Cl. B32B 7/10

(52) U.S. Cl. 428/343

(57) ABSTRACT

A carpet binding tape which abuts the cut edge of the carpet with a glue-filled stitched matrix, resulting in a closer fitting binding than prior art carpet binding tapes.

This invention relates to a new, improved carpet binding tape which abuts the cut edge of the carpet with a glue-filled stitched matrix, resulting in a closer fitting binding than prior art carpet binding tapes.

### BACKGROUND OF THE INVENTION

Carpeting is generally supplied on large rolls with the edges unbound. If the carpeting is installed wall-to-wall, there is no need to bind the edges. If, however, the carpeting is used as a hall or stairway runner or as an area rug or if it is desired to use a remnant as a mat, the carpet edges need to be bound to prevent fraying and to present a pleasing appearance.

The traditional way to bind carpeting is by stitching a binding tape to the cut edges of a carpet. Binding requires heavy duty sewing machines and skilled workers who move the carpet through the machine while an experienced sewing machine operator sews the binding on. Binding is typically done in a special shop, away from the customer's site. While portable carpet binding sewing machines exist, they are very bulky, difficult to handle, and are limited in their use.

Another system for carpet binding involves a stapler and glue gun system. This system is inferior to sewing. The user staples binding tape to the front of the carpet, folds it over the carpet edge, then glues the tape to the back of the carpet. The problem with this system is that the staples sometimes stick out from the binding tape and pose hazards to floor and foot. Furthermore, the process is very time-consuming.

Another system, disclosed in U.S. Pat. No. 7,329,324 to Boatwright, is also available. It consists of a welted carpet tape that uses a double adhesive system: a two-sided tape used to temporarily position the carpet edge on the tape, and a hot melt glue applied with a glue gun to form a permanent bond of tape to the carpet. This system has a number of drawbacks. Among them, the binding leaves a gap between the welting and the carpet fibers. The gap appears as a separation between binding and carpet and is not particularly visually pleasing. In addition, this gap traps dirt and debris and, after a while, becomes even more unsightly.

Another do-it-yourself system, disclosed in U.S. Pat. No. 6,517,922 to Ang and U.S. Pat. No. 6,703,097 to Moffat Devine, is composed of carpet tapes backed with two-sided adhesive strips. The user removes a protective backing from the strip and folds the strip over the cut carpet edge. The drawback to this system is that binding tapes are somewhat stiff pieces of fabric and hard to manage with just fingertip control; thus, it is difficult to get a smooth binding using these tapes. Also, the adhesive is usually insufficient to create a sturdy bond, and the tapes are apt to peel away from the carpet edge, exposing the edge and creating a circumstance where fraying occurs, as well as creating a tripping hazard.

U.S. Pat. No. 6,974,616 discloses a thermoglue binding tape that requires a fusing iron to adhere the tape to the carpet edge.

### SUMMARY OF THE INVENTION

The present invention is an improvement over the prior art carpet binding tapes. It consists of a welted carpet binding tape having a glue-filled stitched matrix surface for adhesion to the carpet edge.

### BRIEF DESCRIPTION OF THE SEVERAL VIEWS OF THE DRAWING

FIG. 1 is a cross section of a preferred embodiment of the carpet binding tape of the present invention.

FIG. 2 is a cross section of the embodiment of FIG. 1 as applied to a carpet edge.

FIG. 3 is an elevation view of the carpet binding tape, showing the stitched matrix surface.

FIG. 4 is a cross section of a second embodiment of the carpet binding tape of the present invention.

FIG. 5 is a perspective view of the carpet binding tape as it appears when applied to a carpet edge.

### DETAILED DESCRIPTION OF THE INVENTION

A preferred embodiment of the present invention is shown in FIGS. 1, 2, 3, and 5. Fabric tape 40 is folded over a welt 41 and secured onto itself, e.g., either sewn or glued, at point 42. Decorative edging material 43, such as e.g. yarn or braiding, is stitched to the fabric tape 40. The stitching thread 44 passes behind edging material 43 at point 45, emerges in front of edging material 43 at point 46, continues downward to point 47 where it passes through fabric tape 40 and then catches edging material 43. Thread 44 then passes through fabric tape 40 at point 48, continues up to a second point 46 where it catches edging material 43. The pattern repeats, creating a welted carpet binding tape, with a decorative outer edge and an inner stitched matrix surface 60.

The user applies glue 51 to a length of the vertical matrix surface 60 and to the horizontal fabric tape 40. Glue 51 may be a specially formulated non-toxic latex fast-drying glue. Carpet edge 52 is then positioned on fabric tape 40 so carpet fibers 53 adhere to matrix surface 60; fabric tape 40 folds along line 49 and the carpet bottom 54 adheres to the fabric tape 40.

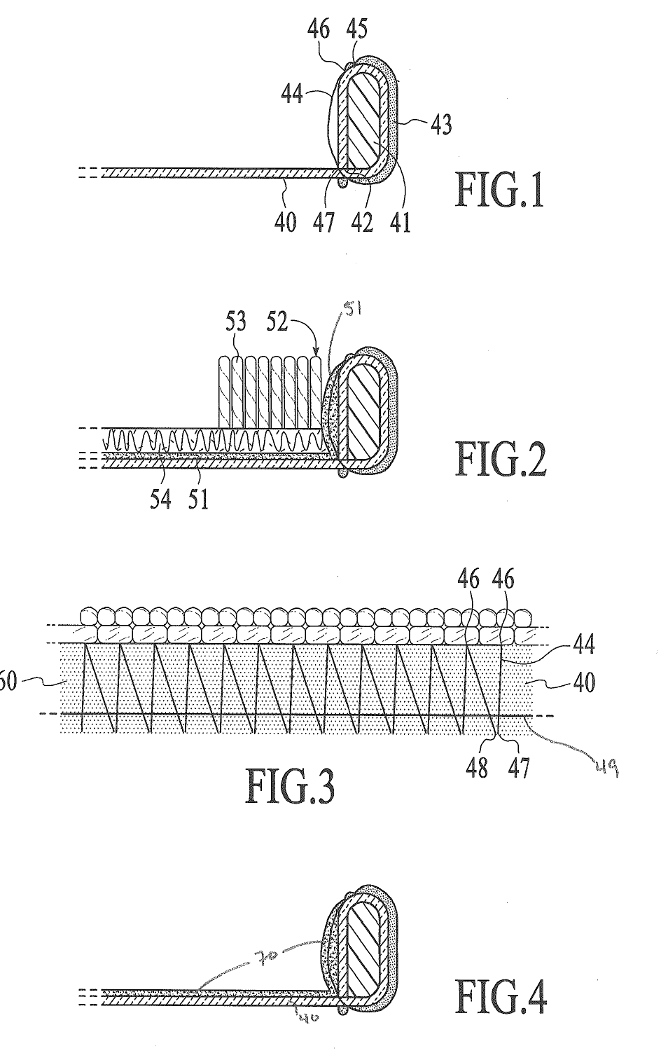

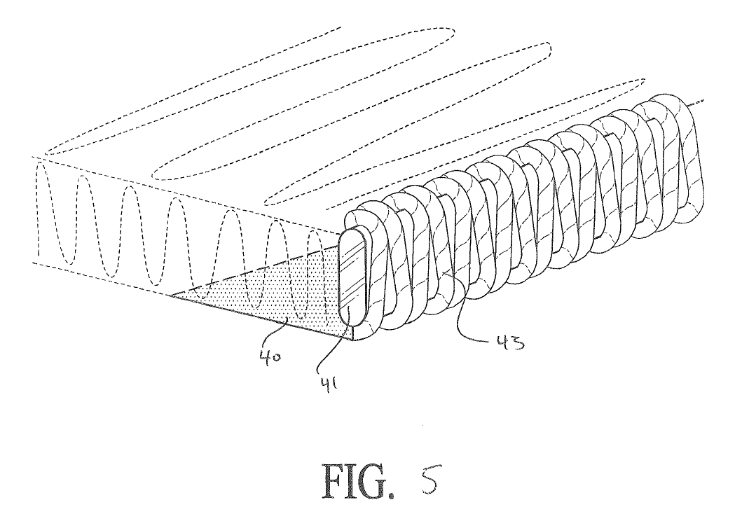

A second embodiment of the invention is shown in FIG. 4. A thermoplastic glue 70 is applied to the matrix surface 60 and the horizontal portion of the fabric tape 40 and allowed to dry. It is positioned on a carpet edge, as shown in FIG. 2, with the fiber edges 53 abutting the matrix surface 60 and the carpet bottom 54 lying atop the horizontal portion of fabric tape 40. The tape and the carpet edge are then run through a specialty iron, disclosed in applicant's application Ser. No. 10/880,793, now allowed. The iron heats and melts the thermoplastic glue while applying pressure on the tape from three sides. As the carpet edge emerges from the iron, it is bound with the carpet tape.

The decorative edging material 43 overlaps the carpet edge to cover imperfections thereof. The line of stitching at points 46 give the carpet tape the appearance of being stitched to the carpet edge.

1. Carpet binding tape comprised of:
a. a fabric tape having an outer side and an inner side, and
b. a stitched matrix attached to the fabric tape and located on a first portion of the inner side thereof.

2. Carpet binding tape according to claim 1 wherein a section of the fabric tape is folded over a welting.

3. Carpet binding tape according to claim 2 further comprising decorative edging located on a first portion of the outer side of the fabric tape.

4. Carpet binding tape according to claim 1 further comprising a layer of glue applied to the stitched matrix and to a second portion of the inner side of the fabric tape, said second portion being contiguous to the first portion.

5. Carpet binding tape according to claim 4 wherein the glue is a non-toxic, latex, fast-drying glue.

6. Carpet binding tape according to claim 4 wherein the glue is a thermoplastic adhesive.
